(19) United States
(12) Patent Application Publication
(10) Pub. No.: US 2026/0285305 A1
(43) Pub. Date: Sep. 24, 2026

(54) VEHICLE CONTROL DEVICE, VEHICLE CONTROL METHOD, AND PROGRAM

(71) Applicant: HONDA MOTOR CO., LTD., Tokyo (JP)

(72) Inventor: Yuki Kitamura, Tokyo (JP)

(21) Appl. No.: 19/551,685

(22) Filed: Feb. 27, 2026

(30) Foreign Application Priority Data
Mar. 21, 2025 (JP) 2025-046266

(51) Int. Cl. B60W 30/10; B60W 30/045

(52) U.S. Cl. CPC B60W 30/10; B60W 30/045; B60W 2520/125; B60W 2552/30

(57) ABSTRACT

A vehicle control device includes: a recognition unit configured to recognize surrounding circumstances of a vehicle, including a curve of a traveling lane on which the vehicle is traveling; and a control unit configured to determine whether to be able to activate a curve departure suppression control that prevents the vehicle from departing from the recognized curve of the traveling lane when the vehicle is likely to depart from the curve, and execute the curve departure suppression control based on a result of the determination, the control unit determining whether to activate the curve departure suppression control based on a first activation possibility condition when the vehicle enters the curve from which the vehicle is likely to depart, and determining whether to activate the curve departure suppression control based on a second activation possibility condition when the vehicle is traveling on the curve from which the vehicle is likely to depart.

### CROSS-REFERENCE TO RELATED APPLICATION

Priority is claimed on Japanese Patent Application No. 2025-046266, filed on Mar. 21, 2025, the contents of which are incorporated herein by reference.

### BACKGROUND

### Field of the Invention

The present invention relates to a vehicle control device, a vehicle control method, and a program.

### Background

In recent years, there have been increasing attempts to provide access to a sustainable transportation system that takes vulnerable traffic participants into consideration. In order to realize this effort, research and development into preventive safety technologies have been focused on in order to further improve road safety and convenience. For example, in the related art, a device has been disclosed that increases the amount of deceleration control when a change in the curvature of a route is large (see, for example, claim 8 in Japanese Unexamined Patent Application, First Publication No. 2004-345505).

### SUMMARY

In the device of the related art, the activation of control for preventing a vehicle from departing from a curved road has not been sufficiently considered.

An object of an aspect of the present invention is to provide a vehicle control device, a vehicle control method, and a program which are capable of appropriately activating control for curbing departure from a curved road. As described above, this aspect of the present invention improves preventive safety technology, and ultimately contributes to development of sustainable transportation systems.

A vehicle control device according to a first aspect of the present invention includes: a recognition unit configured to recognize a surrounding circumstance of a vehicle, including a curve of a traveling lane on which the vehicle is traveling; and a control unit configured to determine whether to be able to activate a curve departure suppression control that prevents the vehicle from departing from the recognized curve of the traveling lane when the vehicle is likely to depart from the curve, and execute the curve departure suppression control based on a result of the determination, the control unit determining whether to activate the curve departure suppression control based on a first activation possibility condition when the vehicle enters the curve from which the vehicle is likely to depart, and determining whether to activate the curve departure suppression control based on a second activation possibility condition when the vehicle is traveling on the curve from which the vehicle is likely to depart.

A second aspect is the vehicle control device according to the first aspect described above, in which the first activation possibility condition may be a condition related to the state of the vehicle when the vehicle is assumed to travel on a curve, and the second activation possibility condition may be a condition related to the shape of the curve.

A third aspect is the vehicle control device according to the first or second aspect described above, in which the first activation possibility condition may be a condition related to the state of the vehicle when the vehicle is assumed to travel on a curve, and the control unit may permit activation of the curve departure suppression control when an index indicating the state of the vehicle is equal to or greater than a threshold value.

A fourth aspect is the vehicle control device according to any one of the first to third aspects described above, in which an index indicating the state of the vehicle may be a turning acceleration of the vehicle when the vehicle turns around the curve, and the control unit may permit activation of the curve departure suppression control when the turning acceleration is equal to or greater than a threshold value.

A fifth aspect is the vehicle control device according to any one of the first to fourth aspects described above, in which the control unit may permit activation of the curve departure suppression control when a time during which a turning acceleration is equal to or greater than a threshold value is equal to or greater than a predetermined time.

A sixth aspect is the vehicle control device according to any one of the first to fourth aspects described above, in which the control unit may not permit activation of the curve departure suppression control when an index related to the shape of the curve is equal to or greater than a threshold value.

A seventh aspect is the vehicle control device according to any one of the first to fifth aspects described above, in which an index related to the shape of the curve may be an index indicating the degree of a change in a curvature of the curve, and the control unit may not permit activation of the curve departure suppression control when the index indicating the degree of the change is equal to or greater than a threshold value.

An eighth aspect is the vehicle control device according to any one of the first to sixth aspects described above, in which the first activation possibility condition may be a condition that a turning acceleration of the vehicle when the vehicle turns around the curve is equal to or greater than a threshold value, the second activation possibility condition may be a condition that an index indicating a degree of a change in a curvature of the curve is equal to or greater than a threshold value, and the control unit may permit activation of the curve departure suppression control when the vehicle enters the curve from which the vehicle is likely to depart and the turning acceleration of the vehicle when the vehicle turns around the curve is equal to or greater than the threshold value, and may not permit activation of the curve departure suppression control when the vehicle is traveling on the curve from which the vehicle is likely to depart and the index indicating the degree of the change in the curvature of the curve is equal to or greater than the threshold value.

A vehicle control method according to a ninth aspect of the present invention includes causing a computer to: recognize a surrounding circumstance of a vehicle, including a curve of a traveling lane on which the vehicle is traveling; determine whether to be able to activate a curve departure suppression control that prevents the vehicle from departing from the recognized curve of the traveling lane when the vehicle is likely to depart from the curve, and execute the curve departure suppression control based on a result of the determination; determine whether to activate the curve departure suppression control based on a first activation possibility condition when the vehicle enters the curve from which the vehicle is likely to depart; and determine whether to activate the curve departure suppression control based on a second activation possibility condition when the vehicle is traveling on the curve from which the vehicle is likely to depart.

A tenth aspect of the present invention is a computer-readable non-transitory storage medium storing a program that causes a computer to: recognize a surrounding circumstance of a vehicle, including a curve of a traveling lane on which the vehicle is traveling; determine whether to be able to activate a curve departure suppression control that prevents the vehicle from departing from the recognized curve of the traveling lane when the vehicle is likely to depart from the curve, and execute the curve departure suppression control based on a result of the determination; determine whether to activate the curve departure suppression control based on a first activation possibility condition when the vehicle enters the curve from which the vehicle is likely to depart; and determine whether to activate the curve departure suppression control based on a second activation possibility condition when the vehicle is traveling on the curve from which the vehicle is likely to depart.

According to the first to tenth aspects, an appropriate activation possibility condition is applied in accordance with the position of the vehicle with respect to the curve, and the curve departure suppression control is executed appropriately. For example, when a curve is recognized using a camera, the vehicle control device can accurately issue a warning when entering the curve by combining appropriate methods in each of predicting the curve when entering the curve and determining the curve during traveling on the curve, and can suppress issuance of a warning when entering the curve during traveling on the curve.

According to any one of the third to fifth aspects, the vehicle control device can appropriately execute the curve departure suppression control when entering a curve. For example, the vehicle control device can reduce annoyance to an occupant by suppressing issuance of a warning when entering the curve.

According to the sixth or seventh aspect, the vehicle control device can appropriately control the curve departure suppression control during traveling on a curve. For example, the vehicle control device can appropriately suppress issuance of a warning during traveling on the curve.

### BRIEF DESCRIPTION OF THE DRAWINGS

FIG. 1 is a configuration diagram of a vehicle system using a vehicle control device according to an embodiment.

FIG. 2 is a diagram illustrating a control executed by a first departure control unit.

FIG. 3 is a diagram illustrating a control executed by a second departure control unit.

FIG. 4 is a diagram illustrating a scene in which a vehicle enters a curve.

FIG. 5 is a diagram illustrating whether activation can be performed.

FIG. 6 is a flowchart showing an example of a flow of processing executed by the second departure control unit.

FIG. 7 is a flowchart showing an example of a flow of basic processing in departure determination.

FIG. 8 is an image view showing a summary of the departure determination.

FIG. 9 is a diagram illustrating an example of a first area AR1 and a second area AR2.

### DESCRIPTION OF EMBODIMENTS

### First Embodiment

### Overall Configuration

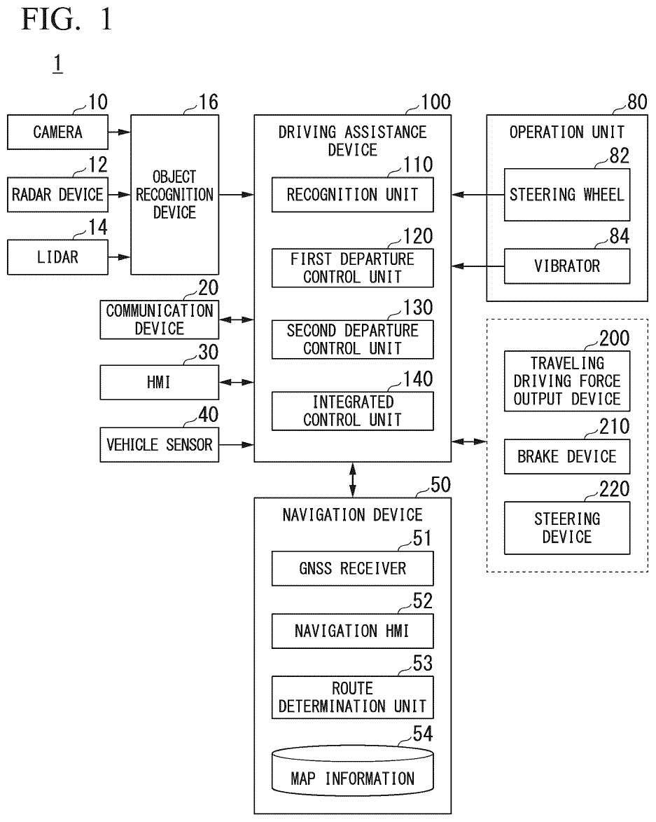

FIG. 1 is a configuration view of a vehicle system 1 using a vehicle control device according to an embodiment. A vehicle in which the vehicle system 1 is mounted is, for example, a two-wheeled, three-wheeled or four-wheeled vehicle, and a driving source thereof is an internal combustion engine such as a diesel engine or a gasoline engine, an electric motor, or a combination thereof. The electric motor is operated using electric power generated by a generator connected to the internal combustion engine, or using discharged electric power from a secondary battery or a fuel cell.

For example, the vehicle system 1 includes a camera 10, a radar device 12, a light detection and ranging (LIDAR) sensor 14, an object recognition device 16, a communication device 20, a human-machine interface (HMI) 30, a vehicle sensor 40, a navigation device 50, an operation unit 80, a driving assistance device 100, a traveling driving force output device 200, a brake device 210, and a steering device 220. These devices and equipment are connected to each other by multiple communication lines, such as a controller area network (CAN) communication line, serial communication lines, wireless communication networks, or the like. Further, the configuration shown in FIG. 1 is merely an example, and some of the components may be omitted, or other components may be added. The driving assistance device 100 is an example of “a vehicle control device.”

For example, the camera 10 is a digital camera using a solid-state imaging element such as, for example, a charge-coupled device (CCD) or a complementary metal oxide semiconductor (CMOS). The camera 10 is attached to any location on a vehicle in which the vehicle system 1 is mounted (hereinafter, a vehicle M). When capturing an image of the front, the camera 10 is attached to a front windshield upper portion, a rearview mirror back surface, or the like. The camera 10 captures images of the surroundings of the vehicle M repeatedly, for example, periodically. The camera 10 may also be a stereo camera.

The radar device 12 emits radio waves, such as millimeter waves, around the vehicle M and detects the radio waves reflected by objects (reflected waves) to detect at least a position (distance and azimuth) of the object. The radar device 12 is attached to the vehicle M at an arbitrary location. The radar device 12 may detect the position and speed of the object using a frequency modulated continuous wave (FM-CW) method.

The LIDAR 14 emits light (or electromagnetic waves with a wavelength close to the light) to the surroundings of the vehicle M, and measures scattered light. The LIDAR 14 detects the distance to the subject on the basis of the time between light emission and reception. The emitted light is, for example, a pulsed laser beam. The LIDAR 14 is attached to an arbitrary position of the vehicle M.

The object recognition device 16 performs sensor fusion processing on some or all of the detection results from the camera 10, the radar device 12, and the LIDAR 14 to recognize the position, the type, the speed, or the like, of the object. The object recognition device 16 outputs the recognition results to the driving assistance device 100. The object recognition device 16 may output the detection results of the camera 10, the radar device 12, and the LIDAR 14 to the driving assistance device 100 as they are. The object recognition device 16 may be omitted from a vehicle system 1.

The communication device 20 communicates with other vehicles in the vicinity of the vehicle M using, for example, a cellular network, a Wi-Fi network, Bluetooth (Registered trademark), dedicated short range communication (DSRC), etc., or communicates with various server devices via a wireless base station.

The HMI 30 presents various pieces of information to the occupant of the vehicle M and accepts input operations from the occupant. The HMI 30 includes, for example, various display devices, a speaker, a buzzer, a touch panel, a switch, and keys. The HMI 30 includes a display device. The display device (display) is, for example, a display device, i.e., a multi-information display, for displaying various information in the vehicle M such as a speedometer indicating a movement speed of the vehicle M or a tachometer indicating a rotational speed of the internal combustion engine provided in the vehicle M provided in the center of the instrument panel of the vehicle M.

The vehicle sensor 40 includes a vehicle speed sensor configured to detect the speed of the vehicle M, an acceleration sensor configured to detect acceleration, a yaw rate sensor configured to detect the angular speed around a vertical axis, an azimuth sensor configured to detect the orientation of the vehicle M, and the like.

The navigation device 50 includes, for example, a global navigation satellite system (GNSS) receiver 51, a navigation HMI 52, and a route determination unit 53. The navigation device 50 stores map information 54 in a storage device such as a hard disk drive (HDD) or a flash memory. The GNSS receiver 51 specifies a position of the vehicle M on the basis of the signal received from a GNSS satellite. The position of the vehicle M may be specified or supplemented by an inertial navigation system (INS) using the output of the vehicle sensor 40. The navigation HMI 52 includes a display device, a speaker, a touch panel, and keys. The navigation HMI 52 may be partially or completely shared with the HMI 30 described above. For example, the route determination unit 53 decides on a route (hereinafter referred to as a route on a map) from the position of the vehicle M identified by the GNSS receiver 51 (or any input position) to a destination input by the occupant using the navigation HMI 52 with reference to the map information 54. The map information 54 is, for example, information in which a road shape is expressed by a link indicating a road and nodes connected by a link. The map information 54 may include a road curvature, point of interest (POI) information, and the like. For example, the map information 54 includes information indicating a specified speed (e.g., a speed limit or a legal speed) for each link indicating a road. The specified speed is information indicating, for example, the speed limit and the legal speed displayed on a road, a signboard provided on a road, or the like.

The navigation device 50 may perform route guidance using the navigation HMI 52 on the basis of the route on map. The navigation device 50 may be realized by, for example, a function of a terminal device such as a smartphone, a tablet terminal, or the like, held by the occupant. The navigation device 50 may transmit the current position and destination to a navigation server via the communication device 20, and acquire the same route as the route on map from the navigation server.

The operation unit 80 includes, for example, an operation switch of a direction indicator, an accelerator pedal, a brake pedal, a shift lever, and other operators (not shown). A sensor that detects an amount of operation or the presence or absence of operation is attached to the operation element, and the detection result is output to the driving assistance device 100 or some or all of the traveling driving force output device 200, the brake device 210, and the steering device 220. The steering wheel does not have to have a ring shape and may have a shape of a deformed steering, a joystick, a button, or the like. A steering grip sensor is attached to the steering wheel.

In addition to the above, the operation unit 80 includes a steering wheel 82 and a vibrator 84.

The vibrator 84 vibrates the steering wheel 82. For example, the vibrator 84 vibrates based on an instruction from the driving assistance device 100 to notify the driver that the vehicle M is approaching a road marking, that the vehicle M has reached a road marking, or that the vehicle M has deviated from a road marking.

The driving assistance device 100 includes, for example, a recognition unit 110, a first departure control unit 120, a second departure control unit 130, and an integrated control unit 140. Some or all of these functional units are implemented, for example, by a hardware processor such as a central processing unit (CPU) executing a program (software). Some or all of such constituent elements may be realized by hardware (a circuit unit; including circuitry) such as a large scale integration (LSI), an application specific integrated circuit (ASIC), a field-programmable gate array (FPGA), a graphics processing unit (GPU), and a system on chip (SOC) or may be realized by software and hardware in cooperation. The program may be stored in a storage device such as an HDD, a flash memory, or the like, (a storage device including a non-transient storage medium) of the driving assistance device 100, or may be stored in a detachable storage medium such as a DVD, a CD-ROM, or the like, in advance, or may be installed in a HDD or a flash memory of the driving assistance device 100 by mounting a storage medium (non-transient storage medium) in a drive device.

The recognition unit 110 recognizes the position of an object in the periphery of the vehicle M and states such as a speed and acceleration thereof on the basis of information input from the camera 10, the radar device 12, and the LIDAR 14 via the object recognition device 16. The position of the object is recognized, for example, as a position on absolute coordinates using a representative point (a center of gravity, a driving shaft center, or the like) of the vehicle M as an origin, and used in control. The position of the object may be expressed by a representative point such as the center of gravity or a corner of the object, or may be expressed by an area.

The “state” of the object may include the acceleration or jerk of the object, or the “action state” (e.g., whether or not the lane is changing or is about to change).

For example, the recognition unit 110 recognizes a road marking near the vehicle M and recognizes a traveling lane on the basis of the recognized road marking. The recognition unit 110 may recognize a traveling lane by recognizing traveling road boundaries (road boundaries), which are not limited to the road marking but include road markings, shoulders, curbs, median strips, guard rails, and the like. This recognition may take into account the position of the vehicle M obtained from the navigation device 50 and the processing results from the INS. The recognition unit 110 recognizes a temporary stop line, an obstacle, red traffic light, a toll gate, other road events, a mark (a speed limit) marked on a road, and a road sign on which the speed limit is marked.

When the traveling lane is recognized, the recognition unit 110 recognizes a position or a posture of the vehicle M with respect to the traveling lane. For example, the recognition unit 110 may recognize a gap of a reference point of the vehicle M from the center of the lane and an angle formed between the movement direction of the vehicle M and a line connected to the center of the lane as a relative position and posture of the vehicle M related to the traveling lane. Instead, the recognition unit 110 may recognize a position of a reference point of the vehicle M with respect to one side line of the traveling lane (a road marking or a road boundary) or the like as the position of the vehicle M with respect to the traveling lane.

### First Departure Control Unit

The first departure control unit 120 prevents the vehicle M from departing from the road while the driver is controlling the vehicle M. The first departure control unit 120 implements a so-called road departure mitigation function (road departure mitigation; RDM). The first departure control unit 120 executes first departure mitigation control when the vehicle M is likely to change lanes or depart from a road marking in a state where a direction indicator is not blinking. Examples of the first departure mitigation control include issuing a warning regarding departure from a road marking recognized by the recognition unit 110, issuing a warning via vibration from the vibrator 84 of the steering wheel 82, and steering assistance to move the vehicle M closer to the center of the lane.

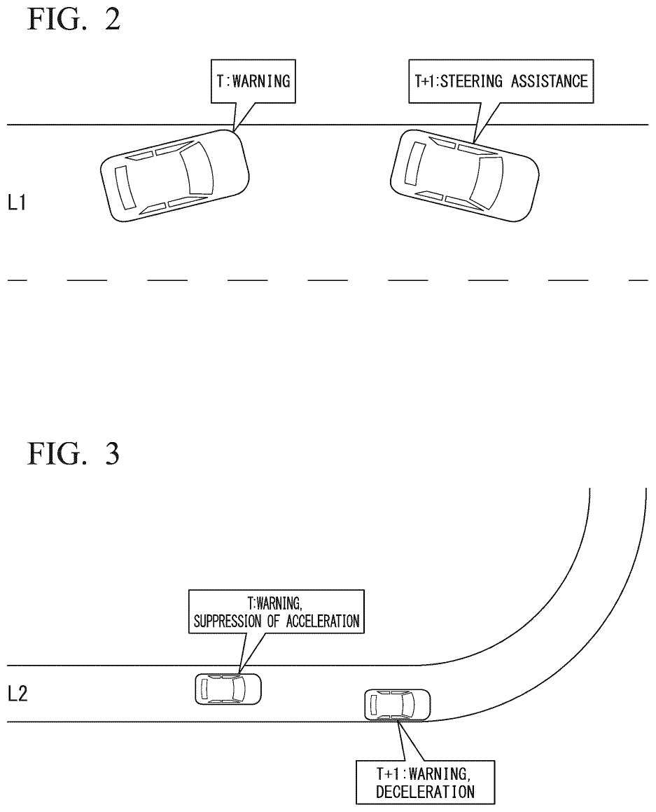

FIG. 2 is a diagram illustrating control executed by the first departure control unit 120. When conditions for first departure control are satisfied at time T, the first departure control unit 120 outputs a warning using the HMI 30. The conditions for the first departure control include the vehicle M reaching a position separated from the center of a lane L1 at a predetermined distance or more or reaching a position separated from the position of a road marking on the lane L1 at a predetermined distance. When the vehicle M is closer to the road marking at time T+1 than the position of the vehicle M at time T, the first departure control unit 120 strengthens the mitigation control more than at time T. Strengthening the mitigation control means, for example, issuing a warning that is more noticeable to a driver, or providing steering assistance to keep the vehicle M in the center of the lane.

By executing the first departure control as described above, the first departure control unit 120 can prevent the vehicle M from departing from the road.

### Second Departure Control Unit

The second departure control unit 130 prevents the vehicle M from departing from a curved road while the driver is controlling the vehicle M. The second departure control unit 130 implements a so-called curved road departure early warning. The second departure control unit 130 executes second departure suppression control when the vehicle M is highly likely to depart from the curved road when the vehicle M approaches the entrance of the curved road.

Examples of the second departure mitigation control include issuing a warning regarding departure from a road marking on the curved road, issuing a warning via vibration from the vibrator 84 of the steering wheel 82, suppressing acceleration of the vehicle M, decelerating the vehicle M, and steering assistance to move the vehicle M closer to the center of the lane. The second departure control unit 130 may also execute second departure mitigation control after the vehicle M enters the curved road when the vehicle M is highly likely to depart from the curved road.

The high likelihood is determined by taking some or all of the following target information into consideration. The target information includes, for example, a radius of curvature of the curved road, the degree of change in curvature of the curved road, an arrival time, and a turning acceleration. The arrival time is, for example, an arrival time it takes for vehicle M to reach a road marking, which is obtained based on the position of the road marking with respect to the vehicle M and the state of the vehicle M (for example, a position, a movement direction, a speed, and an acceleration). The turning acceleration is, for example, a predicted turning acceleration of the vehicle M when the vehicle M turns a curved road. For example, when the radius of curvature of the curved road is equal to or less than a first threshold value, the degree of change in curvature is equal to or greater than a second threshold value, the arrival time is equal to or less than a third threshold value, and the turning acceleration is equal to or greater than a fourth threshold value, it is determined that the vehicle M is highly likely to depart from the curved road, and second departure mitigation control is executed.

FIG. 3 is a diagram illustrating control executed by the second departure control unit 130. For example, when the vehicle M travels in a lane L2 and reaches a position a predetermined distance before the entrance of a curved road that is subject to second departure mitigation control, and there is a risk that the vehicle M will depart from the curved road, the second departure control unit 130 issues a warning and suppresses acceleration to prompt the driver to recognize the curved road. When the driver does not decelerate the vehicle M and the vehicle M travels and further approaches a road marking of the curved road, the second departure control unit 130 will decelerate the vehicle and perform steering assistance in addition to issuing a warning.

The driving assistance device 100 recognizes curves, for example, based on recognition results of the recognition unit 110. The driving assistance device 100 may recognize curves with reference to high-precision map information stored in a storage unit (not shown) of the driving assistance device 100, or may recognize curves based on the high-precision map information and the recognition results of the recognition unit 110. The high-precision map information is detailed map information that includes information indicating the positions of the curves.

By executing the second departure control as described above, the second departure control unit 130 can prevent the vehicle M from departing from the curved road.

In addition to the above-described first departure control and second departure control, the driving assistance device 100 may execute adaptive cruise control (ACC), lane maintenance control for causing the vehicle M to travel in the center of the lane, or control for performing an automatic lane change (ALC) for automatically causing the vehicle M to change lanes when a lane change instruction has been issued by the driver.

The integrated control unit 140 controls, for example, each part of the vehicle M, such as the communication device 20 and the HMI 30.

The traveling driving force output device 200 outputs a traveling driving force (torque) to the driving wheels so that the vehicle travels. The traveling driving force output device 200 includes a combination of, for example, an internal combustion engine, an electric motor, and a gearbox, as well as an ECU that controls these. The ECU controls the above-described components in accordance with information input from the driving assistance device 100 or information input from the driving operation element.

The brake device 210 includes, for example, a brake caliper, a cylinder that transmits a hydraulic pressure to the brake caliper, an electric motor that generates the hydraulic pressure in the cylinder, and a brake ECU. The brake ECU controls the electric motor in accordance with the information input from the driving assistance device 100 or the information input from the driving operator so that brake torque according to a brake operation is output to each wheel.

The steering device 220, for example, includes a steering ECU and an electric motor.

The electric motor, for example, applies a force to a rack and pinion mechanism to change the direction of the steered wheels. The steering ECU drives the electric motor in accordance with the information input from the driving assistance device 100 or the information input from the driving operator to change the direction of the steerable wheels.

### Overview

The second departure control unit 130 of the driving assistance device 100 determines whether to activate curve departure suppression control for preventing the vehicle from departing from a curve in a traveling lane when the vehicle is highly likely to depart from the curve, and executes the curve departure suppression control based on a result of the determination. The determination of a first activation possibility condition below may be executed when the vehicle M arrives at a predetermined distance before the curve (entrance to the curve).

### First Activation Possibility Condition

When the vehicle M enters a curve from which the vehicle M is highly likely to depart, the second departure control unit 130 determines whether to activate curve departure suppression control based on the first activation possibility condition. “When the vehicle M enters the curve” refers to the timing at which the vehicle enters the curve, the timing a predetermined time before entering the curve, the timing at which the vehicle M is positioned near an entrance to the curve, the timing at which the vehicle M is positioned a predetermined distance before the entrance to the curve, and the like.

The first activation possibility condition is a condition related to the state of the vehicle M when it is assumed that the vehicle M is traveling around a curve. The second departure control unit 130 permits the activation of the curve departure suppression control when an index indicating the state of the vehicle M is equal to or greater than a threshold value Th1. The threshold value Th1 may be set to approximately 0.1 G to 0.3 G, or may be set to a value smaller than 0.1 G, such as 0.08 G.

The index indicating the state of the vehicle is a turning acceleration (predicted turning acceleration) of the vehicle M when the vehicle M turns around a curve. The turning acceleration is an acceleration that acts in the direction of the center of the turn when the vehicle M turns. When the turning acceleration is equal to or greater than the threshold value Th1, the second departure control unit 130 permits the activation of curve departure suppression control. When a time during which the turning acceleration is equal to or greater than the threshold value is equal to or greater than a predetermined time, the second departure control unit 130 may permit the activation of curve departure suppression control. Thereby, it is possible to more accurately determine whether to activate curve departure suppression control.

The state of the vehicle M may be the current speed of the vehicle M, a predicted speed when turning, and the like. When the current speed of the vehicle M or the predicted speed when turning is used, a speed corresponding to the radius of curvature of the curve is set as a threshold value. When the above-described speed is equal to or greater than threshold value Th1 corresponding to the radius of curvature of the curve, the second departure control unit 130 permits the activation of curve departure suppression control.

In the above-described processing, the second departure control unit 130 may confirm permission to activate curve departure suppression control when an index indicating the state of the vehicle M continues to be equal to or greater than the threshold value Th1 for a predetermined determination period, or when an index indicating the state of the vehicle M continues to be equal to or greater than the threshold value Th1 for a predetermined time.

### Second Activation Possibility Condition

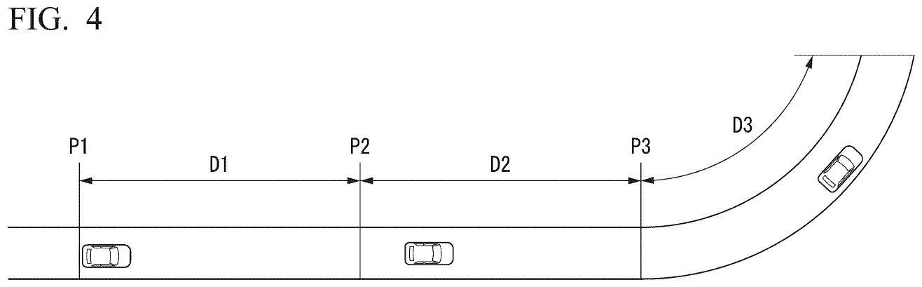

When the vehicle M is traveling on a curve from which the vehicle M is highly likely to depart, the second departure control unit 130 determines activation of curve departure suppression control based on the second activation possibility condition. This determination may also be performed when the vehicle M is not traveling on a curve (this determination may be performed in D1 and D2 in FIG. 4).

The second activation possibility condition is a condition related to the shape of the curve. When an index related to the shape of the curve is equal to or greater than a threshold value Th2, the second departure control unit 130 does not permit the activation of curve departure suppression control.

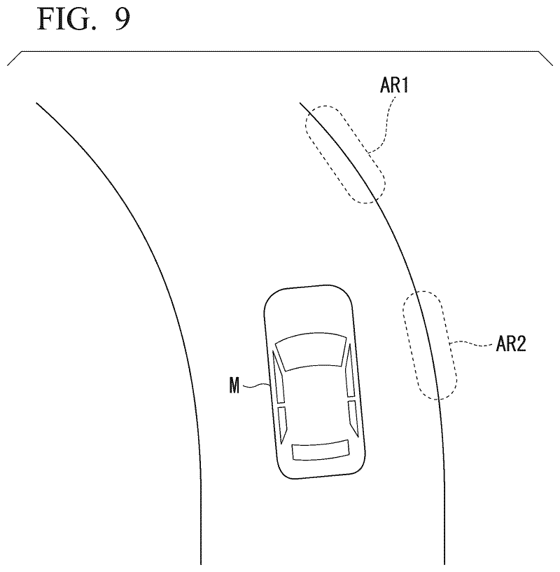

The index related the shape of the curve is an index indicating the degree of change in curvature of the curve. When the index indicating the degree of change is equal to or greater than a threshold value, the first departure control unit 120 does not permit the activation of curve departure suppression control. A method of deriving the degree of change in the curvature of a curve will be described later (see FIG. 9).

An index related to the shape of a curve may be a radius of curvature of the curve or the curvature of the curve in addition to (or instead of) the degree of change in curvature of the curve, or may be an index that uses some or all of the degree of change, the radius of curvature, and the curvature.

### Scene in which Vehicle Enters Curve

FIG. 4 is a diagram illustrating a scene in which the vehicle M enters a curve. The vehicle M passes through positions P1, P2, and P3, in this order and turns around the curve. The position P3 is a position at or near an entrance to the curve. A section D1 is a section from the position P1 to the position P2. A section D2 is a section from the position P2 to the position P3. A section D3 is a section after the position P3.

For example, in the section D1, a predicted turning acceleration (predicted turning acceleration) is less than the threshold value Th1. In this case, the second departure control unit 130 assumes that the vehicle M will travel on a straight road (substantially a straight road) and does not permit the activation of second departure suppression control. The turning acceleration is derived based on, for example, the current speed or predicted future speed of the vehicle M and the curvature of the curve. For example, the second departure control unit 130 estimates a turning acceleration when the vehicle M travels around a curve at its current speed.

For example, in the section D2, the predicted turning acceleration is equal to or greater than threshold value Th1. In this case, the second departure control unit 130 determines that the vehicle M enters a curve and permits the activation of second departure suppression control.

As in the section D1, at a position a predetermined distance before the position P3 which is the entrance of the curve (for example, at a position ahead of the position P), the shape of the curve may not be recognized due to the characteristics or performance of the camera 10 or the recognition unit 110, and the predicted turning acceleration may tend to be derived as being lower than the threshold value Th1. For example, in the section D1, a traveling road ahead may be recognized as a straight road even when it is curved.

When approaching the entrance to the curve as in the section D2, the shape of the curve is recognized appropriately, and a predicted turning acceleration corresponding to the shape of the curve and the speed of the vehicle M is derived.

As described above, when the vehicle M is separated from the entrance of the curve, the predicted turning acceleration is derived tends to be low by the recognition of the shape of the curve, and the second departure suppression control is suppressed. Thereby, annoyance to an occupant is reduced. For example, when the vehicle M is positioned a predetermined distance before the entrance to the curve, the curve is determined to be straight from, for example, the recognition performance of the camera 10 or the recognition unit 110, or the radius of curvature of the curve may be derived as being large. Thereby, when the vehicle M is separated from the entrance to the curve, excessive activation of curve departure suppression control is suppressed.

When the vehicle M is close to the entrance to the curve, a predicted turning acceleration corresponding to the shape of the curve and the speed of the vehicle M is derived, and the activation of second departure suppression control is permitted in accordance with the predicted turning acceleration. Thereby, it is possible to activate second departure suppression control according to the actual behavior of the vehicle M and the shape of the curve.

For example, in the section D3, the degree of change in curvature of the curve is equal to or greater than the threshold value Th2. In this case, the second departure control unit 130 determines that the vehicle M is traveling around the curve and does not permit the activation of second departure suppression control. At this time, first departure suppression control may be executed.

At a position by a predetermined distance before the position P3 which is the entrance to the curve (for example, at a position ahead of the position P2), the determination of whether the second departure control unit can be activated may be omitted, and second departure suppression control may not be activated.

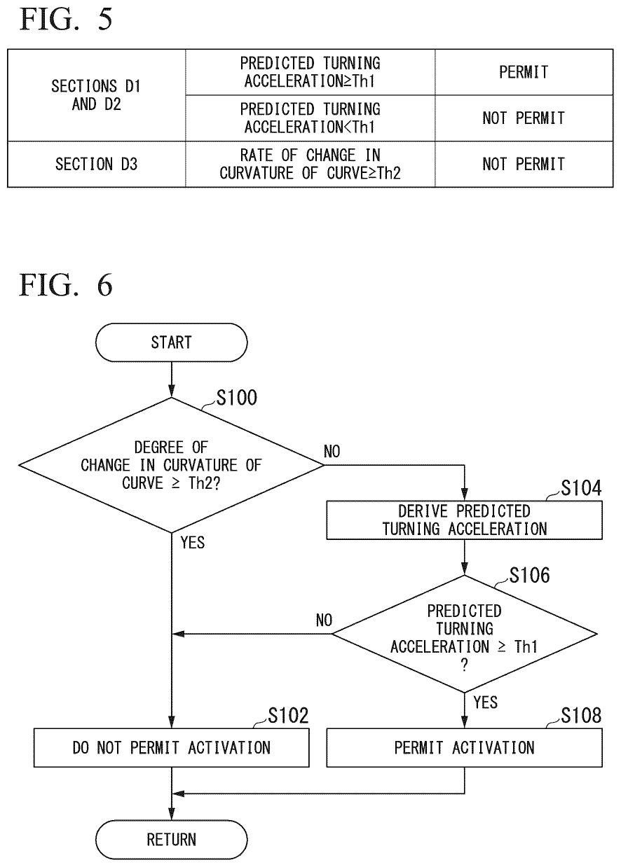

FIG. 5 is a diagram illustrating whether activation can be performed. The second departure control unit 130 permits the activation of second departure suppression control when a predicted turning acceleration is equal to or greater than the threshold value Th1 in the section D1 or D2 before entering a curve. The second departure control unit 130 does not permit the activation of second departure suppression control when the predicted turning acceleration is less than the threshold value Th1 in the section D1 or D2 before entering the curve.

The second departure control unit 130 determines whether the degree of change (for example, a rate of change) in the curvature of a traveling lane in the section D1 or D2 before entering the curve is equal to or greater than the threshold value Th2, and when the degree of change in curvature is equal to or greater than the threshold value Th2, the second departure control unit 130 may not permit the activation of second departure suppression control regardless of the predicted turning acceleration.

In the section D3 after entering the curve, when the degree of change in curvature is equal to or greater than the threshold value Th2, the second departure control unit 130 does not permit the activation of second departure suppression control. In the section D3 after entering the curve, when the degree of change in curvature is less than the threshold value Th2, the second departure control unit 130 may permit the activation of second departure suppression control.

### Flowchart

FIG. 6 is a flowchart showing an example of a flow of processing executed by the second departure control unit 130. First, the second departure control unit 130 determines whether the degree of change in the curvature of a curve is equal to or greater than threshold value Th2 (step S100). When the degree of change in curvature of the curve is equal to or greater than the threshold value Th2, the second departure control unit 130 does not permit the activation of second departure suppression control (step S102). In S102, it is determined whether the degree of change in the curvature of a traveling road or traveling lane of the vehicle M is equal to or greater than the threshold value Th2, and when the degree of change in curvature is equal to or greater than the threshold value Th2, the processing may proceed to step S102, or when the degree of change in curvature is less than the threshold value Th2, the processing may proceed to step S104.

When the degree of change in curvature of the curve is not equal to or greater than the threshold value Th2 (when the degree of change in curvature of the curve is less than the threshold value Th2), the second departure control unit 130 derives a predicted turning acceleration (step S104). The second departure control unit 130 determines whether the predicted turning acceleration is equal to or greater than the threshold value Th1 (step S106).

When the predicted turning acceleration is equal to or greater than the threshold value Th1, the second departure control unit 130 permits the activation of second departure suppression control (step S108). When the predicted turning acceleration is not equal to or greater than the threshold value Th1 (when the predicted turning acceleration is less than the threshold value Th1), the second departure control unit 130 does not permit the activation of second departure suppression control (step S102). Thereby, the processing of one routine of this flowchart ends.

### Permission Conditions After Activation is Permitted

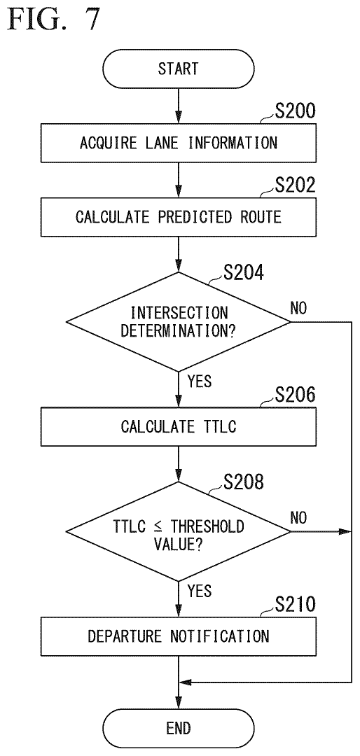

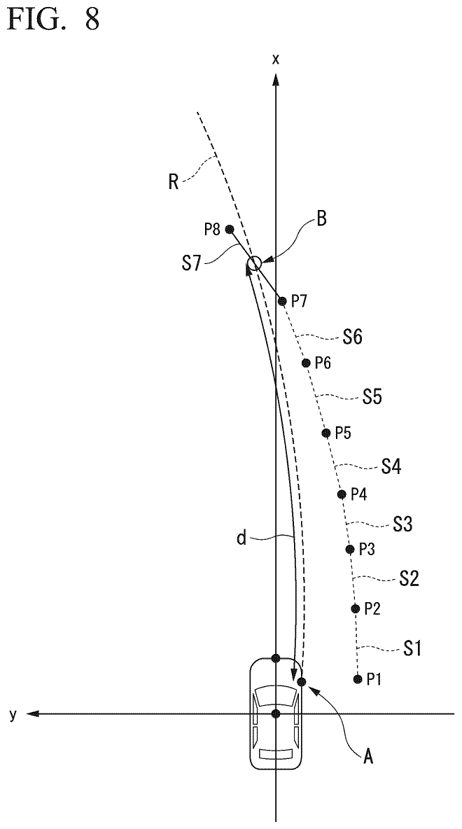

After activation is permitted, permission conditions are satisfied when the following departure determination is affirmative, and the activation is started. FIG. 7 is a flowchart showing an example of a flow of basic processing in departure determination. FIG. 8 is an image view showing a summary of departure determination. Hereinafter, the flow of the processing in FIG. 7 will be described with reference to FIG. 8. First, the second departure control unit 130 acquires lane information of a lane in which a host vehicle is traveling (S200). The lane information is information that represents, as point groups for each predetermined interval, marking lines of a lane in which the vehicle is traveling. While the accuracy of departure determination decreases when the point group interval is excessively large, a control period of the departure determination becomes short and a processing load increases when the point group interval is excessively short, and thus the point group interval may be designed to an appropriate interval (for example, an interval of 1 m) depending on the processing performance, desired determination accuracy, or the like. While the processing load increases when a marking line to be processed in each control period is excessively long (that is, there are an excessively large number of point groups), it becomes difficult to predict lane departure when the marking line to be processed is excessively short, and thus the length of the marking line to be processed in each control period may be designed to an appropriate length (for example, 100 m or the like) depending on the processing performance, predictability of lane departure, or the like. For example, as shown in FIG. 8, the lane information may be acquired as a set of coordinates Pn={P1, P2, P3, . . . } indicating the relative position of the host vehicle for a marking line far from the curvature center of the curve. Hereinafter, the set Pn is referred to as a marking line point group Pn.

Next, the second departure control unit 130 calculates a predicted route for the host vehicle based on a vehicle speed and a yaw rate of the host vehicle (S202), and determines whether the predicted route intersects the marking line (S204: intersection determination). Here, when it is determined that the predicted route does not intersect the marking line, that is, when there is no intersection between the predicted route and the marking line, the second departure control unit 130 ends the departure determination of this period. Meanwhile, in S204, when it is determined that the predicted route will intersect with the marking line, that is, when there is an intersection between the predicted route and the marking line, the second departure control unit 130 calculates a predicted time (TTLC) until the host vehicle reaches an intersection position (S206), and determines whether the TTLC is equal to or less than a predetermined threshold value (S208). Here, when it is determined that the predicted time is greater than the threshold value, the second departure control unit 130 ends the departure determination of this period. Meanwhile, in S208, when it is determined that the predicted time is equal to or less than the threshold value, the second departure control unit 130 gives a notification indicating that the host vehicle is departing from the lane (S210: departure notification), and ends the departure determination of this period.

In step S210, instead of issuing the departure notification, the speed or steering of the vehicle M may be controlled to prevent the vehicle M from departing.

FIG. 8 is an example of a case where a predicted route R of the host vehicle intersects a line segment S7 formed by P7 and P8 in the marking line point group Pn. In this case, the second departure control unit 130 calculates the predicted route R of the host vehicle and determines whether a line segment n (n=1, 2, . . . ) formed by two adjacent points of the marking line point group Pn intersects the predicted route R, starting with the one closest to the host vehicle.

Here, the line segment n is a line segment formed by Pn and Pn+1. In the case of the example in FIG. 8, the second departure control unit 130 can detect an intersection B between the predicted route R and the marking line in the line segment S7 (n=7) by determining whether the line segment intersects the predicted route R (intersection determination), starting from a line segment S1 (n=1). Hereinafter, a point where a predicted route and a marking line intersect is referred to as a “departure point”. The second departure control unit 130 can calculate a time required for the host vehicle to reach a departure point B from its initial position as TTLC.

More specifically, the second departure control unit 130 calculates, as the predicted route R of the host vehicle, a movement trajectory of an area of the host vehicle which is highly likely to first intersect (depart from) a marking line (hereinafter referred to as a “target area”). Here, as an example, an outer end portion of a right front tire of the host vehicle is defined as a target area, but other areas may be defined as a target area from a similar perspective. For example, a ground-contact point of the right front tire may be a target area, or the right end portion of the front of the vehicle body may be a target area. The second departure control unit 130 can obtain the TTLC by obtaining a distance d (hereinafter referred to as a “departure route length”) from an initial position A of the target area to the departure point B and dividing the departure route length d by the moving speed of the target area.

When the threshold value of the TTLC is excessively large, a hurdle for a departure notification will be lowered, even situations that do not require much attention will be notified, and departure notifications that require high attention may be mixed up with other departure notifications, increasing the level of risk. When the threshold value of the TTLC is excessively large, the frequency of departure notifications will increase, resulting in a possibility that annoyance to an occupant will increase. When the threshold value of the TTLC is excessively small, there will be no time to recover the behavior of the host vehicle after receiving the departure notification, resulting in a possibility that the level of risk will increase. For this reason, the threshold value of the TTLC may be designed to an appropriate value (for example, 1 second or the like) from the viewpoint of comfort and safety of occupants.

When the control period is excessively short, the number of point groups that can be processed will decrease, whereas when the control period is excessively long, lane departures cannot be detected at a required timing. For this reason, the control period may be designed to an appropriate value (for example, 10 milliseconds or the like) from the viewpoint of the number of point groups to be processed in one period and a detection timing required for lane departure. Each of the above-mentioned design elements is set appropriately to provide an appropriate combination of values in relation to other design elements.

As described above, since the second departure control unit 130 can perform departure determination based on a predicted route of the turning and moving vehicle M, it is possible to more appropriately perform the departure determination when the vehicle M travels around a curve.

### Degree of Change in Curvature of Curve

The degree of change in the curvature of a curve is obtained as follows: The second departure control unit 130 acquires a curvature of a first area of a traveling road and a curvature of a second area of the traveling road. FIG. 9 is a diagram illustrating an example of a first area AR1 and a second area AR2. The first area AR1 is, for example, an area in front of the vehicle M. The first area AR1 is, for example, an area several meters or several tens of meters in front of the vehicle M. The first area AR1 may be changed depending on the speed and acceleration of the vehicle M. The second area AR2 is, for example, an area to the side of the vehicle M or an area that the vehicle M has passed through.

The second departure control unit 130 compares the curvature of the first area AR1 with the curvature of the second area AR2 to determine the degree of change in curvature. The second departure control unit 130, for example, determines the degree of change in curvature of the first area AR1 with respect to the curvature of the second area AR2. The second departure control unit 130 may obtain the degree of change in curvature based on the shape of a road marking on one side, or may obtain the degree of change in curvature based on the shapes of the road markings on both sides. The road marking on one side may be a road marking on an outer side of the vehicle M (on the side opposite to a direction in which the steering wheel is turned) or may be a road marking on the side opposite thereto. When using the road markings on both sides, the second departure control unit 130 may perform statistical processing on the degree of change in curvature obtained from each road marking to obtain the degree of change to be used to set a threshold value. When the road markings on both sides are used, a larger degree of change in curvature may be preferentially adopted.

As described above, by using the degree of change in the first area and the degree of change in the second area, the second departure control unit 130 can more appropriately obtain the degree of change in the curvature of a curve, and can more appropriately obtain whether the vehicle M is traveling around a curve. Research has shown that, among various areas, using the above-mentioned first area and second area is appropriate when determining whether the vehicle M is traveling around a curve.

According to the embodiment described above, the driving assistance device 100 determines whether to be able to perform a curve departure suppression control that prevents the vehicle M from departing from a curve when the vehicle M is likely to depart from a recognized curve of the traveling lane, and executes the curve departure suppression control based on a result of the determination. When the vehicle M enters a curve from which the vehicle M is likely to depart, the driving assistance device 100 determines to activate the curve departure suppression control based on a first activation possibility condition, and when the vehicle M is traveling on a curve from which the vehicle M is likely to depart, the driving assistance device 100 determines whether to activate the curve departure suppression control based on a second activation possibility condition, thereby making it possible to assist in more appropriately preventing the vehicle from departing from a road marking depending on an environment.

The embodiment described above can be expressed as follows.

A control device including:
a storage device storing a program; and
a hardware processor, the control device is configured such that
the hardware processor executes the program stored in the storage device to
recognize surrounding circumstances of a vehicle, including a curve of a traveling lane in which the vehicle is traveling,
determine whether to be able to activate a curve departure suppression control that prevents the vehicle from departing from the recognized curve of the traveling lane when the vehicle is likely to depart from the curve, and execute the curve departure suppression control based on a result of the determination,
determine whether to activate the curve departure suppression control based on a first activation possibility condition when the vehicle enters the curve from which the vehicle is likely to depart, and
determine whether to activate the curve departure suppression control based on a second activation possibility condition when the vehicle is traveling on the curve from which the vehicle is likely to depart.

As described above, although a form for performing the present invention has been described using the embodiment, the present invention is not limited to such an embodiment at all, and various modifications and substitutions can be applied within a range not departing from the concept of the present invention.

What is claimed is:

1. A vehicle control device comprising:
a recognition unit configured to recognize a surrounding circumstance of a vehicle, including a curve of a traveling lane on which the vehicle is traveling; and
a control unit configured to determine whether to be able to activate a curve departure suppression control that prevents the vehicle from departing from the recognized curve of the traveling lane when the vehicle is likely to depart from the curve, and execute the curve departure suppression control based on a result of the determination, the control unit
determining whether to activate the curve departure suppression control based on a first activation possibility condition when the vehicle enters the curve from which the vehicle is likely to depart, and
determining whether to activate the curve departure suppression control based on a second activation possibility condition when the vehicle is traveling on the curve from which the vehicle is likely to depart.

2. The vehicle control device according to claim 1,
wherein the first activation possibility condition is a condition related to a state of the vehicle when the vehicle is assumed to travel on a curve, and
the second activation possibility condition is a condition related to a shape of the curve.

3. The vehicle control device according to claim 1,
wherein the first activation possibility condition is a condition related to a state of the vehicle when the vehicle is assumed to travel on a curve, and
the control unit permits activation of the curve departure suppression control when an index indicating the state of the vehicle is equal to or greater than a threshold value.

4. The vehicle control device according to claim 1,
wherein an index indicating a state of the vehicle is a turning acceleration of the vehicle when the vehicle turns around the curve, and
the control unit permits activation of the curve departure suppression control when the turning acceleration is equal to or greater than a threshold value.

5. The vehicle control device according to claim 4,
wherein the control unit permits activation of the curve departure suppression control when a time during which the turning acceleration is equal to or greater than a threshold value is equal to or greater than a predetermined time.

6. The vehicle control device according to claim 1,
wherein the control unit does not permit activation of the curve departure suppression control when an index related to a shape of the curve is equal to or greater than a threshold value.

7. The vehicle control device according to claim 6,
wherein the index related to the shape of the curve is an index indicating a degree of a change in a curvature of the curve, and
the control unit does not permit activation of the curve departure suppression control when the index indicating the degree of the change is equal to or greater than a threshold value.

8. The vehicle control device according to claim 1,
wherein the first activation possibility condition is a condition that a turning acceleration of the vehicle when the vehicle turns around the curve is equal to or greater than a threshold value,
the second activation possibility condition is a condition that an index indicating a degree of a change in a curvature of the curve is equal to or greater than a threshold value, and
the control unit
permits activation of the curve departure suppression control when the vehicle enters the curve from which the vehicle is likely to depart and the turning acceleration of the vehicle when the vehicle turns around the curve is equal to or greater than the threshold value, and
does not permit activation of the curve departure suppression control when the vehicle is traveling on the curve from which the vehicle is likely to depart and the index indicating the degree of the change in the curvature of the curve is equal to or greater than the threshold value.

9. A vehicle control method comprising causing a computer to:
recognize a surrounding circumstance of a vehicle, including a curve of a traveling lane on which the vehicle is traveling;
determine whether to be able to activate a curve departure suppression control that prevents the vehicle from departing from the recognized curve of the traveling lane when the vehicle is likely to depart from the curve, and execute the curve departure suppression control based on a result of the determination;
determine whether to activate the curve departure suppression control based on a first activation possibility condition when the vehicle enters the curve from which the vehicle is likely to depart; and
determine whether to activate the curve departure suppression control based on a second activation possibility condition when the vehicle is traveling on the curve from which the vehicle is likely to depart.

10. A computer-readable non-transitory storage medium storing a program that causes a computer to:
recognize a surrounding circumstance of a vehicle, including a curve of a traveling lane on which the vehicle is traveling;
determine whether to be able to activate a curve departure suppression control that prevents the vehicle from departing from the recognized curve of the traveling lane when the vehicle is likely to depart from the curve, and execute the curve departure suppression control based on a result of the determination;
determine whether to activate the curve departure suppression control based on a first activation possibility condition when the vehicle enters the curve from which the vehicle is likely to depart; and
determine whether to activate the curve departure suppression control based on a second activation possibility condition when the vehicle is traveling on the curve from which the vehicle is likely to depart.
